(19) United States
(12) Patent Application Publication
(10) Pub. No.: US 2023/0292779 A1
(43) Pub. Date: Sep. 21, 2023

(54) BYPASSING CURD-WASH IN CONTINENTAL CHEESE MAKING

(71) Applicant: Chr. Hansen A/S, Hoersholm (DK)

(72) Inventors: Mia Ryssel, Hoersholm (DK); Thomas Baek Pedersen, Hoersholm (DK); Peter Beierholm Poulsen, Hoersholm (DK); Sebastien Roustel, Hoersholm (DK)

(73) Assignee: Chr. Hansen A/S, Hoersholm (DK)

(21) Appl. No.: 17/927,126

(22) PCT Filed: May 28, 2021
(86) PCT No.: PCT/EP2021/064394

§ 371 Date: Nov. 22, 2022

(30) Foreign Application Priority Data
May 28, 2020 (EP) 20177092.2

(51) Int. Cl. A23C 19/032; A23C 19/068

(52) U.S. Cl. CPC A23C 19/0323; A23C 19/0688; A23Y 2240/41; A23Y 2240/75

(57) ABSTRACT

The present invention relates to compositions and methods for producing continental cheese in a non-wash process.

### CROSS-REFERENCE TO RELATED APPLICATIONS

The present application is the U.S. National Stage of International Application No. PCT/EP2021/064394, filed May 28, 2021, and claims priority to European Patent Application No. 20177092.2, filed May 28, 2020.

### FIELD OF THE INVENTION

The present invention relates to novel culture compositions of lactic acid bacteria allowing for bypassing the curd-wash step in continental cheese making.

### BACKGROUND ART

In a typical cheese manufacturing process for making continental type cheese the milk is subjected to a number of sequential steps comprising:
1) Heat treatment: 72° C./15 sec, cooling to 31-33° C.
2) Culture addition and pre-ripening: 15-45 min
3) Renneting: Add rennet, 31-33° C., 25-40 min
4) Cutting and Stirring: cut into 5-10 ml cubes. Stir for 1-25 min
5) Washing: removal of a whey volume equivalent to 35-40% of initial milk volume. Add 25-30% of initial milk volume as hot water.
6) Pre-press: 20 min at 2-4 bar.
7) Molding and pressing: Pressing time from 30-90 min at 0-6 bar.
8) Salting: e.g. by brining.
9) Storage/Ripening

As known by the person skilled in the art, the process may be amended and adjusted beyond the temperature, pressure, time and volume intervals given above.

An important parameter in the continental cheese is the final pH of the cheese. After salting (or brining), the pH value of the cheese must be above 5.15 and it must not decrease during the ripening stage and storage.

To control the final pH, and because the continental cheese production recipes uses mesophilic cultures, the traditional process requires a washing step (step 5) above to decrease the lactose content in the curd before the acidification. By that way, the acidification stops when all the lactose is consumed and the final pH does not drop below the desired value.

The washing step as outlined in step 5) typically comprise:
removal of a defined volume of whey (from 10 to 50%)
adding a defined volume of water (from 10 to 50%)

The quantities may depend on the type of cheese, and the lactose content in the milk which may vary with the season, the kind of cows, etc.

Removing whey and adding heated water as part of the washing step serves to achieve the desired result but impose several undesirable factors relating to water, energy and time consumption as well as e.g. yield-loss due to removal of dry matter. Furthermore the washing step requires a prolonged stay of the milk in the cheese vat thereby limiting the throughput in the cheese production line.

Because of the significant costs and drawbacks associated with the washing step, cheese makers have attempted to remove this step by various means.

However, removing the washing step in the production process imposes a number of risks related to:
post-acidification
undesirable taste / flavor development
undesirable texture development
proteolysis
reduced shelf life

The most commonly used approach applied in attempt to bypass the washing step in continental cheese has been to use thermophilic cultures only. The rationale of using thermophilic cultures is the opportunity to stop the growth of the thermophilic cultures by lowering the temperature, according to the temperature profile of the cheese manufacturing process. However, using thermophilic cultures only has resulted in unsatisfactory proteolysis, undesirable flavor and shortened shelf life.

### SUMMARY OF THE INVENTION

The problem to be solved by the present invention is to provide compositions allowing production of continental cheese in a so called non-wash process, i.e. where washing (step 5 above) is excluded or minimized.

As disclosed herein, the present inventors have found that by using a culture composed by a mixture of:
Lactococcus lactis with low post acidification,
Lactose negative Lactococcus lactis and
Sensitive Streptococcus thermophilus with low post acidification, the desired flavor and texture profile may be achieved while improving yields and resources.

The culture composed by a mixture of: Lactococcus lactis, Lactose negative Lactococcus lactis and Sensitive Streptococcus thermophilus with low post acidification and optionally a chemical booster is herein referred to as a ‘NWC culture’.

The NWC culture may optionally be combined with other components such as e.g. a specific coagulant enzyme to allow bypassing- or minimize the washing step while obtaining the desired acidification, texture and taste of the produced cheese.

### DETAILED DESCRIPTION OF THE INVENTION

As disclosed herein, by omitting the washing step and by using a special culture composition, we are able to increase the yield by 2-3% (moisture adjusted).

More specifically, the results show that the yield increase for the NWC process compared to a reference process gives a higher yield when the same reference culture was used in the two different processes. When the NWC process is combined with the new special NWC culture as claimed herein, then the yield increase is even higher.

The term Non Washed Curd (NWC) process are used for the process where the washing step is omitted or minimized, and the special culture are used. A flow chart for producing continental cheese with and without washing can be seen in FIG. 1.

When the special NWC culture is use in a normal Gouda process with washing the yield seems to decrease a bit.

Hence, it is the combination of omitting the washing step and using the special NWC culture that gives the highest yield increase.

A large increase in yield is shown when replacing the reference process with the NWC process using a regular Gouda culture. However, this solution is not suitable because of postacidification/low pH of the cheese, which can be seen in FIG. 3 herein.

In summary, the results presented herein show that the regular culture, such as e.g. a Gouda culture cannot be used for the NWC process, since it gives a too low pH in the cheese due to the post-acidification. Therefore the special NWC culture needs to be used.

The culture architecture enables the control of the post-acidification because the Streptococcus thermophilus and the Lactococcus lactis have low post-acidification. The contribution of the flavor in the cheese is mostly due to the lactose negative Lactococcus lactis.

Non-limiting examples of culture-compositions as used herein include (unless otherwise stated % is %W/W:
NWC1) 6% Lactococcus lactis with low post acidification, 25% Streptococcus thermophilus with low post acidification, 63% Lactose negative Lactococcus lactis and 6% chemical booster comprising formiate,
NWC2) 37% Lactococcus lactis with low post acidification, 26% Streptococcus thermophilus with low post acidification, 31% Lactose negative Lactococcus lactis and 6% chemical booster comprising formiate
NWC3) 42.5% Lactococcus lactis with low post acidification, 16% Streptococcus thermophilus with low post acidification, 33.5% Lactose negative Lactococcus lactis and 8% chemical booster.

Accordingly the culture or composition of present invention may comprise from 2% to 60% Lactococcus lactis low post acidification, from 5% to 75% Streptococcus thermophilus with low post acidification and from 15%-80% lactose negative Lactococcus lactis and from 1 to 20% chemical booster.

More specifically the invention relates to a composition of lactic acid bacteria for making continental cheese, the composition comprising a blend of: Lactococcus lactis with low post acidification, lactose negative Lactococcus lactis, sensitive Streptococcus thermophilus with low post acidification and optionally a chemical booster.

In related aspects the invention relates to a composition comprising from 2% to 60% Lactococcus lactis with low post acidification, from 5% to 75% sensitive Streptococcus thermophilus with low post acidification and from 15% to 80% lactose negative Lactococcus lactis and optionally from 1% to 20% chemical booster.

The composition may be supplied as frozen pellets, such as e.g. as a Direct Vat Set culture.

The Lactococcus lactis with low post acidification may comprise a mixture of different Lactococcus lactis strains sharing the same phenotype.

The Streptococcus thermophilus with low post acidification may comprise a mixture of different Streptococcus thermophilus strains sharing the same phenotype.

The lactose negative Lactococcus lactis may be supplied as a mixture of different lactose negative Lactococcus lactis sharing the same phenotype.

In a preferred aspect, the Lactococcus lactis with low post acidification is characterized by acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w). In a related aspect the Streptococcus thermophilus with low post acidification is characterized by acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w).

The composition of present invention may be used for the manufacture of several cheese types including but not limited to the continental cheese types selected from a list consisting of: Gouda, Edam, Maasdamer, Havarti, Danbo and Tilsiter.

In some aspects the continental cheese does not include cheese of the manchego and grana type.

In a preferred aspect, the continental cheese is produced in a non-wash (NWC) process.

As outlined herein, the present invention also relates to a method for producing a continental type cheese, the method comprising:
a) Adding a composition according of present invention to a milk composition
b) Optionally pre-ripening
c) Renneting
d) Cutting and Stirring
e) Washing the milk composition
f) Optionally pre-pressing the milk composition
g) Molding and pressing
h) Salting: e.g. by brining,
wherein water added during washing step e) is less than 10% of the initial milk volume.

Step a) may be preceded by heating the milk to around 72° C. for 5-60 secs and/or cooling the milk to 31-35° C.

The rennet applied in step c) may preferably be a chymosin with low unspecific proteolysis such as e.g. camel chymosin or a variant thereof or bovine chymosin or a variant thereof.

The method of present invention may further comprise a drying step between step d) and f) wherein the curd is dried before molding to reduce wet matter and control the moisture content of the cheese.

As known by the person skilled in the art, the process may be amended and adjusted beyond the temperature, pressure, time and volume intervals given above.

Hence in one aspect, the invention relates to a composition comprising Lactococcus lactis with low post acidification, lactose negative Lactococcus lactis, sensitive Streptococcus thermophilus with low post acidification and optionally a chemical booster.

### DEFINITIONS

All definitions of relevant terms are in accordance with what would be understood by the skilled person in relation to the herein relevant technical context.

The term “chymosin” relates to an enzyme of the EC 3.4.23.4 class. Chymosin has a high specificity and predominantly clots milk by cleavage of a single 105-Ser-Phe-|-Met-Ala-108 bond in kappa-chain of casein. As a side-activity, chymosin also cleaves β-casein primarily between Leu192 and Tyr193. The resulting peptide β(193-209) will be further degraded by proteases to short hydrophobic peptides that taste bitter. An alternative name of chymosin used in the art is rennin.

The term “chymosin activity” relates to chymosin activity of a chymosin enzyme as understood by the skilled person in the present context.

The skilled person knows how to determine herein relevant chymosin activity.

As known in the art – the herein relevant so-called C/P ratio is determined by dividing the specific clotting activity (C) with the proteolytical activity (P).

As known in the art – a higher C/P ratio implies generally that the loss of protein during e.g. cheese manufacturing due to non-specific protein degradation is reduced, i.e. the yield of cheese is improved.

“Fermentation” in the methods of the present invention means the conversion of carbohydrates into alcohols or acids through the action of a microorganism. Preferably, fermentation in the methods of the invention comprises conversion of lactose to lactic acid.

Fermentation processes to be used in production of fermented milk products are well known and the person of skill in the art will know how to select suitable process conditions, such as temperature, oxygen, amount and characteristics of microorganism(s) and process time. Obviously, fermentation conditions are selected so as to support the achievement of the present invention, i.e. to obtain a dairy product in solid or liquid form (fermented milk product).

The term “initial milk volume” means the volume of milk initially procured before commencing the method according to the present invention, e.g. the total milk volume in a cheese vat before step 1 of the herein described method.

The term “milk” is to be understood as the lacteal secretion obtained by milking any mammal, such as a cow, a sheep, a goat, a buffalo or a camel. In a preferred embodiment, the milk is cow’s milk.

The term “milk substrate” may be any raw and/or processed milk material that can be subjected to fermentation according to the method of the invention. Thus, useful milk substrates include, but are not limited to, solutions/suspensions of any milk or milk like products comprising protein, such as whole or low fat milk, skim milk, buttermilk, reconstituted milk powder, condensed milk, dried milk, whey, whey permeate, lactose, mother liquid from crystallization of lactose, whey protein concentrate, or cream. Obviously, the milk substrate may originate from any mammal, e.g. being substantially pure mammalian milk, or reconstituted milk powder.

The term “mature polypeptide” means a peptide in its final form following translation and any post-translational modifications, such as N terminal processing, C terminal truncation, glycosylation, phosphorylation, etc. In the present context may a herein relevant mature chymosin polypeptide be seen as the active chymosin polypeptide sequence - i.e. without the pre-part and/or pro-part sequences.

The term “non-wash process” means a process for making continental cheese, wherein the washing step is omitted or minimized e.g. wherein water is added in a volume less than 10%, such as e.g. 7%, 5%, 3%, 1% or 0% of the initial milk volume during the washing step (e.g. step 5 in the process as outlined herein) in the cheese making process.

The term “parent” or “parent polypeptide” means a polypeptide to which an alteration is made to produce the enzyme variants of the present invention. The parent may be a naturally occurring (wild-type) polypeptide or a variant thereof.

The term “thermophilic culture” means a culture which can most typically withstand temperatures up to 50° C. and thus are commonly used when the curds are not heated above that temperature such as when making Swiss or harder Italian cheeses.

The term “variant” means a peptide having chymosin activity comprising an alteration, i.e., a substitution, insertion, and/or deletion, at one or more (several) positions. A substitution means a replacement of an amino acid occupying a position with a different amino acid; a deletion means removal of an amino acid occupying a position; and an insertion means adding 1-3 amino acids adjacent to an amino acid occupying a position.

The amino acid may be natural or unnatural amino acids – for instance, substitution with e.g. a particularly D-isomers (or D-forms) of e.g. D-alanine could theoretically be possible.

The term “wild-type” chymosin peptide means a chymosin expressed by a naturally occurring organism, such as a mammalian (e.g. camel or bovine) found in nature.

In a preferred aspect, the Lactococcus lactis with low post acidification is characterized by acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w). In a related aspect the Streptococcus thermophilus with low post acidification is characterized by acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w).

The term “Lactococcus lactis with low post acidification” is defined as a Lactococcus lactis which does not acidify a milk containing 3.5% protein to a pH lower than pH 5.5 after 6 hours at 37° C. when inoculated at a rate of 0.01%W/W

The term “sensitive Streptococcus thermophilus with low post acidification” is defined as a Streptococcus thermophilus acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w) with a start pH of 7. By other terms the sensitive Streptococcus thermophilus with low post acidification are in this case defined by the following feature points or functional characteristics:

| Feature point, in milk with 3.5% protein and an inoculation of 0.01% (w/w) | 35° C. | 37° C. | 40° C. |
|---|---|---|---|
| pH interval after 6 hours | [5.8-6.2] | [5.6-6.1] | [5.2-5.9] |

Hence the S. thermophilus of present invention may be considered as being sensitive to temperature.

The term “Lactose negative Lactococcus lactis” means a naturally occurring Lactococcus lactis phenotype unable to utilize lactose and an energy source.

The term “chemical booster” means a chemical compound or blends of compounds which accelerates the growth or performance the bacterial culture. Examples of chemical boosters include: formic acid, a formate, inosinate (IMP), serine and a compound involved in the biosynthesis of nucleic acids, including adenosine-5′-monophosphate (AMP), guanosine-5′-monophosphate (GMP), uranosine-5′-monophosphate (UMP), cytidine-5′-monophosphate (CMP), adenine, guanine, uracil, cytosine, adenosine, guanosine, uridine, cytidine, hypoxanthine, xanthine, hypoxanthine, orotidine, thymidine and inosine. Typically, the term booster do not comprise nutrients, vitamins or sugars.

The present invention is further described as numbered items inserted below:

1. A composition of lactic acid bacteria for making continental cheese, the composition comprising a blend of: Lactococcus lactis with low post acidification, lactose negative Lactococcus lactis, sensitive Streptococcus thermophilus with low post acidification and optionally a chemical booster.

2. A composition according to item 1 comprising from 2% to 60% Lactococcus lactis with low post acidification, from 5% to 75% sensitive Streptococcus thermophilus with low post acidification and from 15% to 80% lactose negative Lactococcus lactis and optionally from 1% to 20% chemical booster.

3. A composition according to any of items 1 and 2 wherein the composition is supplied as frozen pellets, such as e.g. as a Direct Vat Set culture.

4. A composition according to any of items 1 to 3 wherein the Lactococcus lactis with low post acidification comprise a mixture of different Lactococcus lactis sharing the same phenotype.

5. A composition according to any of items 1 to 4 wherein the Streptococcus thermophilus with low post acidification comprise a mixture of different Streptococcus thermophilus strains sharing the same phenotype.

6. A composition according to any of items 1 to 5 wherein the lactose negative Lactococcus lactis is supplied as a mixture of different lactose negative Lactococcus lactis sharing the same phenotype.

7. A composition according to any of the preceding items wherein the Lactococcus lactis with low post acidification is characterized by acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w).

8. A composition according to any of the preceding items wherein the Streptococcus thermophilus with low post acidification is characterized by acidifying a milk with 3.5% protein by between 0.8 to 1.2 pH units when incubated at 35° C., 0.9 to 1.4 pH units when incubated at 37° C., and 1.1 to 1.8 pH units when incubated at 40° C., when inoculated in the milk at 0.01% (w/w).

9. A composition according to any of items 1 to 8 wherein the continental cheese is selected from a list consisting of: Gouda, Edam, Maasdamer, Havarti, Danbo and Tilsiter.

10. A composition according to any of the preceding items wherein the continental cheese does not include cheese of the manchego and grana type.

11. A composition according to any of the preceding items wherein the continental cheese is produced in a non-wash (NWC) process.

12. A method for producing a continental type cheese, the method comprising:

| | |
|---|---|
| a) | Adding a composition according to any of items 1 to 11 to a milk composition |
| b) | Optionally pre-ripening |
| c) | Renneting |
| d) | Cutting and Stirring |
| e) | Washing the milk composition |
| f) | Optionally pre-pressing the milk composition |
| g) | Molding and pressing |
| h) | Salting: e.g. by brining, |

wherein water during washing step e) is less than 10% of the initial milk volume.

13. A method according to item 12, wherein step a) is preceded by heating the milk to around 72° C. for 5-60 secs and/or cooling the milk to 31-35° C.

14. A method according to any of items 12 or 13 wherein the blend of lactic acid bacteria comprise from 2% to 60% Lactococcus lactis with low post-acidification.

15. A method according to any of items 12 to 14 wherein the composition according to any of items 1 to 11 comprise from 5% to 75% Streptococcus thermophilus with low post acidification.

16. A method according to any of items 12 to 15 wherein the composition according to any of items 1 to 11 comprise from 15% to 80% lactose negative Lactococcus lactis.

17. A method according to any of item 12 to 16 wherein the rennet applied in step c) is chymosin with low unspecific proteolysis such as e.g. camel chymosin or a variant thereof or bovine chymosin or a variant thereof.

18. A method according to any of items 12 to 17 further comprising a drying step between step d) and f) wherein the curd is dried before molding to reduce wet matter and control the moisture content of the cheese.

19. The method according to any of items 12 to 18 wherein the continental type cheese is Edam, Gouda, Continental processed cheese and/or Maasdamer.

Further, the invention relates to the use of a composition according to any of items 1-11 in a process for making continental cheese wherein the process comprise less than
a) Adding a the composition according to any of items 1 to 11 to a milk composition
b) Optionally pre-ripening the milk composition
c) Renneting the milk composition
d) Cutting and Stirring the milk composition
e) Washing the milk composition
f) Optionally pre-pressing the milk composition
g) Molding and pressing the milk composition
h) Salting: e.g. by brining,
wherein water added during washing step e) is less than 10% of the initial milk volume, such as e.g. from 0 to 10% of the initial milk volume.

### DRAWINGS

FIG. 1: Schematic example of the cheese manufacturing process for making continental cheese with washing and without washing.

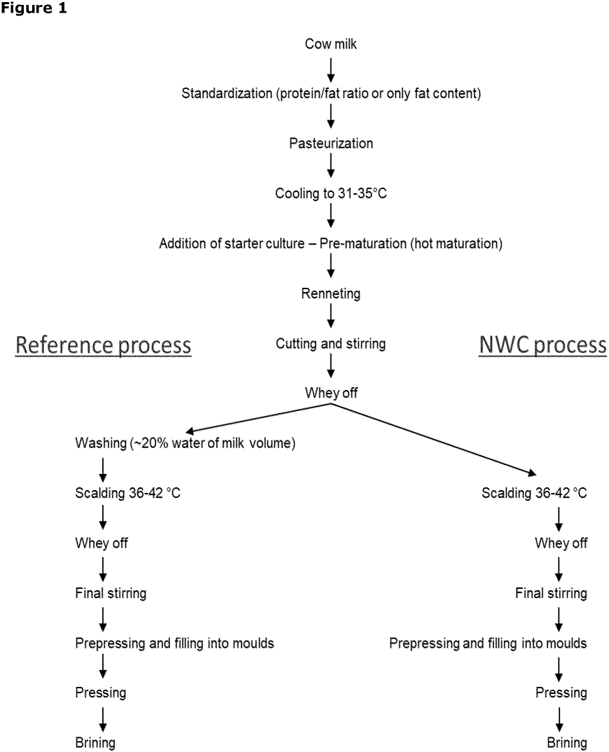

FIG. 2. Overview of the mass balance of mass, fat and protein are shown for the two different processes. Input in the process are shown as blue circles and the milk. Output are shown in the yellow (cheese), brown (whey) and red (samples) circles.

FIG. 3. The pH development in the cheese at 1 day, 14 days, 6 weeks and 12 weeks.

### EXAMPLES

### Example 1

To prove the yield increase the mass balance for the water, fat and protein has been followed during the cheese production according to the processes laid out below.

The target cheese composition is 44% of moisture, 40% of fat in dry matter and 1.7% of total salt. The pH values of the cheese with the traditional process are 5.85 before brining, 5.30 after brining and more than 5.65 after 75 days of ripening and storage.
A) Conventional continental cheese making process
   1: Milk treatment (Fat — Protein — pH standardization, Pasteurization, Cooling)
   2: Culture addition (pre-ripening 5 to 60 minutes)
   3: Renneting (temperature 30 to 35° C., total coagulation: 12 to 40 minutes)
   4: Cutting (grain curd size 27 to 343 mm3)
   5: Stirring (10 to 25 minutes)
   6: Whey removed (20 to 50 % of total volume)
   7: Water adding (10 to 50 % of total volume, 35 to 50° C.)
   8: Stirring + scalding (20 to 60 minutes, final temperature 36 to 43° C.)
   9: Whey removed (facultative)
   10: Draining + Molding
      Draining + pre-pressing 20 minutes + curd cutting + molding
      Draining in perforated tubes + cutting + molding
   11: Pressing - Acidification (40 to 120 minutes)
   12: Demolding
   13: Salt brine (depend of the cheese size)
   14: Storage - Ripening (6 to 20° C., 5 to 52 weeks)
B) Continental cheese making process with no curd washing
   1: Milk treatment (Fat — Protein — pH standardization, Pasteurization, Cooling)
   2: Culture addition (pre-ripening 5 to 60 minutes)
   3: Renneting (temperature 30 to 35° C., total coagulation: 12 to 40 minutes)
   4: Cutting (grain curd size 8 to 125 or 343 mm3)
   5: Stirring (10 minutes)
   6: Whey removed (20 to 30 % of total volume)
   7: Stirring + scalding (40 to 60 minutes, final temperature 36 to 43° C.)
   8: Whey removed (facultative)
   9: Draining + Molding
      Draining + pre-pressing 20 minutes + curd cutting + molding
      Draining in perforated tubes + cutting + molding
   10: Pressing - Acidification (40 to 120 minutes)
   11: Demolding
   12: Salt brine (depend of the cheese size)
   13: Storage – Ripening (6 to 20° C., 5 to 52 weeks)

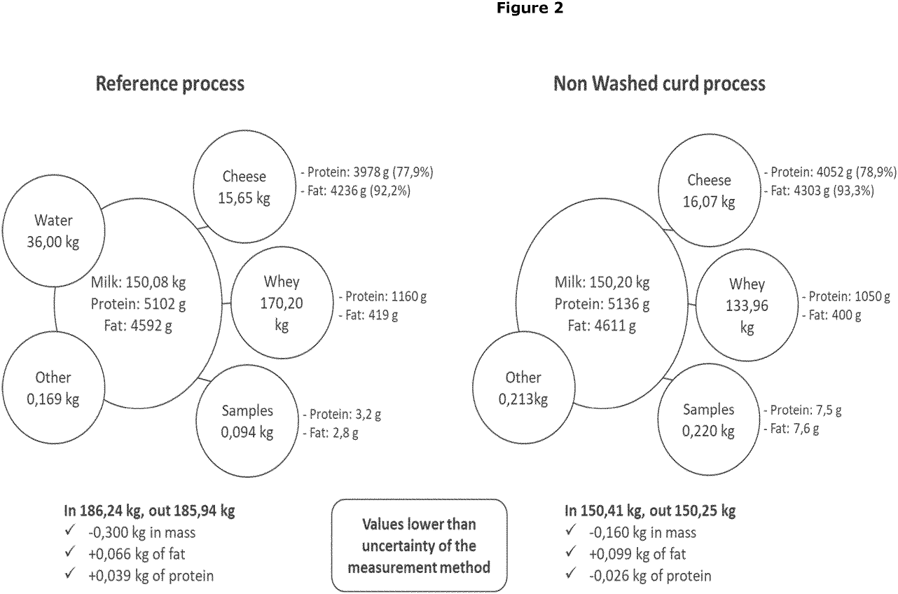

FIG. 2 provides and overview of the mass balance of mass, fat and protein for the two different processes. Input in the process are shown as blue circles and the milk. Output are shown in the yellow (cheese), brown (whey) and red (samples) circles.

As apparent from FIG. 2, the cheese yield when applying the non washed curd process exceeds the yield obtained by the conventional process.

### Example 2

To test if the yield increase was due to the change in process or change in culture, the following were tested in 150 liters vats and the mass balance was followed:
a) Reference (Gouda production with washing and with a regular Gouda culture (C950))
b) Reference without washing (Gouda production without washing, with a regular Gouda culture (C950))
c) Non-washed-curd with washing (Gouda production with washing, but made with the special NWC culture)
d) Non-washed-curd (Gouda production without washing with the special NWC culture)

An overview of the process parameter used to produce the cheeses are shown in table 1.

TABLE 1

Process parameters

| Production of: | Gouda 45+ | | | | | | | |
|---|---|---|---|---|---|---|---|---|
| Treatment | Ref(C950 with wash) | | C950 without wash | | NWC-culture with wash | | NWC-cuture without wash | |
| | Time | Value | Time | Value | Time | Value | Time | Value |
| Add milk and stir | 07:45 | 235 | 08:15 | 235 | 08:45 | 235 | 09:15 | 235 |
| Add afilact and CaCl₂ | 07:55 | | 08:25 | | 08:55 | | 9:25 | |
| Add culture | 08:00 | 31.5° C. | 08:30 | 31.5° C. | 09:00 | 31.5° C. | 09:30 | 31.5° C. |
| Add rennet | 08:35 | | 09:05 | | 09:35 | | 10:05 | |
| Cutting 1 | 09:10 | 10 mm | 09:40 | 10 mm | 10:10 | 10 mm | 10:40 | 10 mm |
| Cutting 2 | 09:15 | 10 mm | 09:45 | 10 mm | 10:15 | 10 mm | 10:45 | 10 mm |
| Cutting 3 | 09:20 | 5 mm | 09:50 | 5 mm | 10:20 | 5 mm | 10:50 | 5 mm |
| Pre-stirring | 09:25 | 235 mm | 09:55 | 235 rpm | 10:25 | 235 mm | 10:55 | 235 rpm |
| Whey off 1 | 09:40 | 42 kg | 10:10 | 42 kg | 10:40 | 42 kg | 11:10 | 42 kg |
| Scald start | 09.50 | 36 kg/52° C. | 10:20 | 30 kg/57C° | 10:50 | 30 kg/57° C. | 11:20 | 30 kg/57° C. |
| Scald end/middle stir | 10:10 | 38.5° C. | 10:40 | 38.5° C. | 11:10 | 38.5° C. | 11:40 | 38.5° C. |
| Whe-y off 2 | 10:50 | 28.5 kg | 11:20 | 0 kg | 11:50 | 28.5 kg | 12:20 | 0 kg |
| Final stirring | 10:55 | 386 rpm | 11:25 | 386 rpm | 11:55 | 386 rpm | 12:25 | 386 rpm |
| End of Stirring | 11:25 | | 11:55 | | 12:25 | | 12:55 | |
| Pre-Pressing 1 | 11:30 | 1 bar | 12:00 | 1 bar | 12:30 | 1 bar | 13:00 | 1 bar |
| Pre-pressing 2 | 11:40 | 2 bar | 12:40 | 2 bar | 12:40 | 2 bar | 13:10 | 2 bar |
| Pre-pressing end | 11:55 | | 12:25 | | 12:55 | | 13:25 | |
| Filling in monkis | 11:55 | | 12:25 | | 12:55 | | 13:25 | |
| Pressing 1 | 12:00 | 2 bar | 12:30 | 2 bar | 13:00 | 2 bar | 13.30 | 2 bar |
| Pressing 2 | 12:15 | 3.5 bar | 12:45 | 3.5 bar | 13:15 | 3.5 bar | 13:45 | 3.5 bar |
| Pressing 3 | 12:30 | 5 bar | 13:00 | 5 bar | 13:30 | 5 bar | 14.00 09.15 | 5 bar |
| Pressing end | 13:00 | | 13:30 | | 14:00 | | 14:30 | |
| In brine | 13:15 | | 13:45 | | 14:15 | | 14:45 | |
| Out of brine | 07:15 | | 07:45 | | 08:15 | | 08:45 | |
| salting | 18 hours, 22% brine, 10° C., pH 5.2 | | 18 hours, 22% brine, 10° C., pH 5.2 | | 18 hours, 22% brine, 10° C., pH 5.2 | | 18 hours, 22% brine, 10° C., pH 5.2 | |
| Packing | Vacuum bags | | Vacum bags | | Vacuum bags | | Vacuum bags | |
| Storage 1 | 9° C. | in 3 week(s) | 9° C. | in 3 week(s) | 9° C. | in 3 week(2 s) | 9° C. | in 3 week(s) week(s) |
| Storage 2 | 4° C. | for storage | 4° C. | for storage | 4° C. | for storage | 4° C. | for storage |

The result of the trial is shown in table 2. From table 2 it is confirmed that the culture composition of the culture provides the biggest effect on yield.

TABLE 2

The moisture adjusted cheese yield from 100 kg milk are shown for the different processes and different cultures

| | Ref (C950 with wash) | C950 without wash | NWC-culture with wash | NWC-culture without wash |
|---|---|---|---|---|
| Corrected yield | 11.09 | 11.30 | 11.06 | 11.39 |
| Fat recovery | 95.23 | 95.37 | 94.77 | 95.71 |
| Prot. Recovery | 80.31 | 81.87 | 80.17 | 82.57 |
| DM Recovery | 52.37 | 53.36 | 52.23 | 53.78 |
| Fat/DM | 47.36 | 46.55 | 47.26 | 46.35 |
| DM | 60.05 | 60.62 | 58.86 | 59.48 |
| MFFB | 55.83 | 54.86 | 57.00 | 55.94 |
| Cheese mass after brine | 15.53 | 15.67 | 15.80 | 16.10 |
| ECY (Economical cheese yield [%]) (compared to Ref) | | 0.90 | 1.72 | 3.61 |
| MACY (moisture adjusted cheese yield [%]) (compared to ref) | | 1.89 | -0.27 | 2.71 |

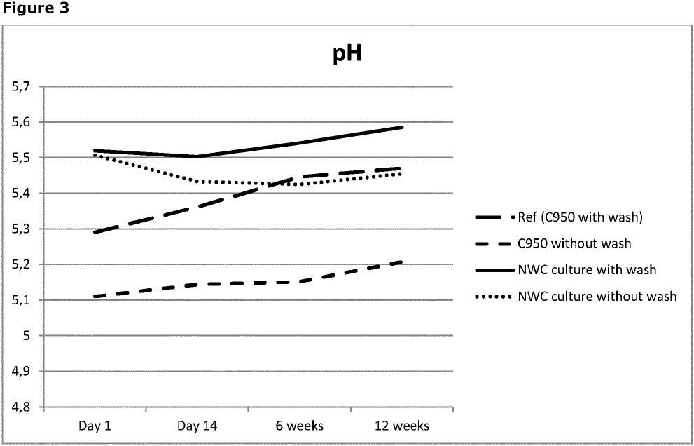

The pH development in the cheese at 1 day, 14 days, 6 weeks and 12 weeks is shown in FIG. 3.

Overall, the results show that the yield increase for the NWC process compared to a reference process does give a higher yield (1.9%) when the same reference culture was used in the two different processes. When the NWC process is combined with the new special NWC culture as claimed herein, then the yield increase is even higher (2.7%).

When the special NWC culture is use in a normal Gouda process with washing the yield seems to decrease a bit.

Hence, it is the combination of omitting the washing step and using the special NWC culture that gives the highest yield increase.

A large increase in yield is shown when going from the reference process to the NWC process using a regular Gouda culture. This solution is not suitable because of postacidification/low pH of the cheese, which can be seen in FIG. 3. FIG. 3, shows the pH development during ripening of the cheeses with the different processes and different cultures. These results show that the regular Gouda culture cannot be used for the NWC process, it gives a too low pH in the cheese due to the postacidification. Therefore the special NWC culture needs to be used.

### Example 3

The yield increase by the NWC process as applied in example 2 and the NWC culture composition was confirmed at a commercial scale field trial. In this trial, 2 reference vats (control vats with washing and a regular Gouda culture) and 2 NWC vats (process without washing and with the special NWC culture) were produced. The size of the vats were 17.000 liters of milk. The result of the trial can be seen in the table 3.

TABLE 3

shows the results of the field trial done with 17.000 liters in each vat. 2 reference vats (control) and two NWC vats was tested and compared

| Weight | REFERENCE VATS | | TRIAL VATS | |
|---|---|---|---|---|
| | control 1 | control 2 | NWC 1 | NWC 2 |
| Before brine | | | | |
| Total weight | 3423 | | 3529 | |
| Weight per vat | 1665.1 | 1668.4 | 1703.3 | 1825.7 |
| Moisture | 43.48% | 42.90% | 43.36% | 45.57% |
| Target moisture | 43.50% | | 43.50% | |
| Weight corrected with 43.5% H₂O | 1665.8 | 1691.7 | 1708.8 | 1742.8 |
| Comparing NWC 1 / control 1 | | | 43.0 | |
| Comparing NWC 1 / control 1 | | | 2.58% | |
| Comparing NWC 2 / control 2 | | | | 51.0 |
| Comparing NWC 2 / control 2 | | | | 3.02% |

These results confirm that a yield increase of 2-3% is possible when using the NWC process and the special NWC culture in commercial scale.

We claim:

1. A lactic acid bacteria composition comprising (i) Lactococcus lactis with low post acidification, (ii) lactose negative Lactococcus lactis, (iii) temperature sensitive Streptococcus thermophilus with low post acidification, and, optionally, (iv) a chemical booster.

2. (canceled)

3. A composition according to claim 1, comprising from 2% to 60% of the Lactococcus lactis with low post acidification, from 5% to 75% of the temperature sensitive Streptococcus thermophilus with low post acidification, from 15% to 80% of the lactose negative Lactococcus lactis, and, optionally, from 1% to 20% of the chemical booster.

4. A composition according to claim 1, wherein the Lactococcus lactis with low post acidification acidifies a milk with 3.5% protein by between 0.8 to 1.2 pH units when incubated at 35° C., by 0.9 to 1.4 pH units when incubated at 37° C., and by 1.1 to 1.8 pH units when incubated at 40° C., when inoculated in the milk at 0.01% (w/w).

5. A composition according to claim 1, wherein the temperature sensitive Streptococcus thermophilus with low post acidification acidifies a milk with 3.5% protein by between 0.8 to 1.2 pH units when incubated at 35° C., by 0.9 to 1.4 pH units when incubated at 37° C., and by 1.1 to 1.8 pH units when incubated at 40° C., when inoculated in the milk at 0.01% (w/w).

6-9. (canceled)

10. A method according to claim 16, wherein the lactic acid bacteria composition comprise from 2% to 60% of the Lactococcus lactis with low post-acidification.

11. A method according to claim 16, wherein the lactic acid bacteria composition comprises from 5% to 75% of the temperature sensitive Streptococcus thermophilus with low post acidification.

12. A method according to claim 16, wherein the lactic acid bacteria composition comprises from 15% to 80% of the lactose negative Lactococcus lactis.

13. A method according to claim 17, wherein step (c) comprises adding one or more selected from camel chymosin and variants thereof and bovine chymosin and variants thereof.

14. A method according to claim 17, further comprising a drying step between step (d) and step (f), further comprising drying the curd before molding to reduce wet matter and control moisture content of the cheese.

15. The method according to claim 16, wherein the continental type cheese is selected from Edam, Gouda, Continental processed cheese, and Maas-damer.

16. A method for producing a continental type cheese, comprising (a) adding a composition according to claim 1 to a milk composition.

17. The method according to claim 16, further comprising:
(b) optionally, pre-ripening the milk composition;
(c) renneting the milk composition;
(d) cutting and stirring the milk composition to obtain a milk composition comprising curd and whey;
(e) washing the milk composition with a volume of water;
(f) optionally, pre-pressing the milk composition;
(g) molding and pressing the milk composition to obtain cheese; and
(h) salting the cheese;
wherein the volume of water added during washing step (e) is less than 10% of the volume of the milk composition at step (a).
